(19) United States
(12) Patent Application Publication
(10) Pub. No.: US 2008/0088142 A1
(43) Pub. Date: Apr. 17, 2008

(54) Silicone coated tong heads

(75) Inventors: Katherine Melissa Lubenesky, New York, NY (US); Conor McNamara, Brooklyn, NY (US); Paul Katz, New York, NY (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 11/581,614

(22) Filed: Oct. 16, 2006

(51) Int. Cl. B25B 9/02

(52) U.S. Cl. 294/16; 294/99.2

(57) ABSTRACT

A silicone coated kitchen tong, which can be used as either a cooking utensil, mixing tool, or food service tool, is disclosed. There is disclosed herein an improved kitchen utensil, such as tongs, comprising a first arm and a second arm, each arm comprising a grasping end, a body, and a pivot end, wherein the first and second arms are pivotally connected to one another at their respective pivot ends, the grasping end of each arm comprising a head made of a flexible core material and at least a substantial portion of the head being covered by a flexible outer material.

### TECHNICAL FIELD

The present invention relates to kitchen utensils. More specifically, the present invention relates to kitchen tongs used to handle food items, particularly food items in surface-coated containers.

### BACKGROUND OF THE INVENTION

Traditional non-stick cooking pans and mixing bowls can sometimes be easily scratched or marred by abrasive or sharp kitchen utensils, especially if the pans and bowls are only thinly-coated with such a non-stick material. Subsequent washing of a scratched pan or bowl can lead to further deterioration of the non-stick quality of the container beginning at the scratch. Such deterioration may include peeling, flaking, or otherwise elimination of the desired surface coating, thereby essentially destroying the container. Even some alternate container surfaces (i.e., not non-stick) can be scratched, chipped, cracked or the like, when exposed to prolonged use with harsh cooking utensils. For this reason, spoons, spatulas and turners are more and more likely to have contacting ends which are either coated with or made from a resilient material, such as silicone, to prevent scratching and marring of expensive container surfaces.

Kitchen tongs, however, may not have been considered by those skilled in the art as a food preparation utensil, but rather as a food serving utensil. It may be that these two areas of kitchen utensils are viewed differently by designers of such devices. Whatever the reasons, tongs have consistently been manufactured with heads made from the same material as the arms. Tongs of the common form include a pair of pivoting arms, usually made of a metal or a hard plastic, and integral grasping ends or heads on each arm made of the same material. It is this hard material which can reduce an expensive container to a less effective tool.

Until the present device, prior art devices have not addressed this problem with kitchen tongs or may have failed to recognize the problem entirely. The shortcomings of prior devices may be due to a perception that a softer tong head would be too flimsy or inadequate for its intended purpose. Nonetheless, the present invention is unique in that it addresses this, as well as other problems found in the prior art. By providing a kitchen tong which is sturdy, capable of handling a variety of items, and is non-abrasive to container surfaces of all types, the present invention addresses such problems.

### SUMMARY OF THE INVENTION

There is disclosed herein an improved kitchen utensil, such as tongs, comprising a first arm and a second arm, each arm comprising a grasping end, a body, and a pivot end, wherein the first and second arms are pivotally connected to one another at their respective pivot ends, the grasping end of each arm comprising a head made of a flexible core material and at least a substantial portion of the head being covered by a flexible outer material.

In an embodiment of the present invention, the kitchen utensil comprises a head having a flexible core made of flex steel or the like. The flexible outer material which coats or covers a portion of the head is preferably silicone.

In another embodiment of the present invention, the tong heads may also comprise a slight transverse bow for improved structural integrity.

These and other aspects of the invention will become apparent from the detailed description below and the appended drawing figures.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

The construction and operation of the present invention as described in detail in the text below may be more readily understood with reference to the appended drawing figures where:

FIG. 1 is a perspective view illustrating one embodiment of the present tongs heads;

FIG. 2 is an exploded view of a single tong head illustrating an embodiment of the present tongs;

FIG. 3 is a cross sectional view of an embodiment of a single tong head; and

FIG. 4 is a perspective view illustrating another embodiment of the present tongs heads.

### DETAILED DESCRIPTION OF THE INVENTION

While the invention is susceptible of embodiment in many different forms, this disclosure will describe in detail preferred embodiments of the invention with the understanding that the present disclosure is to be considered as an exemplification of the principles of the invention and is not intended to limit the broad aspect of the invention to the embodiments illustrated.

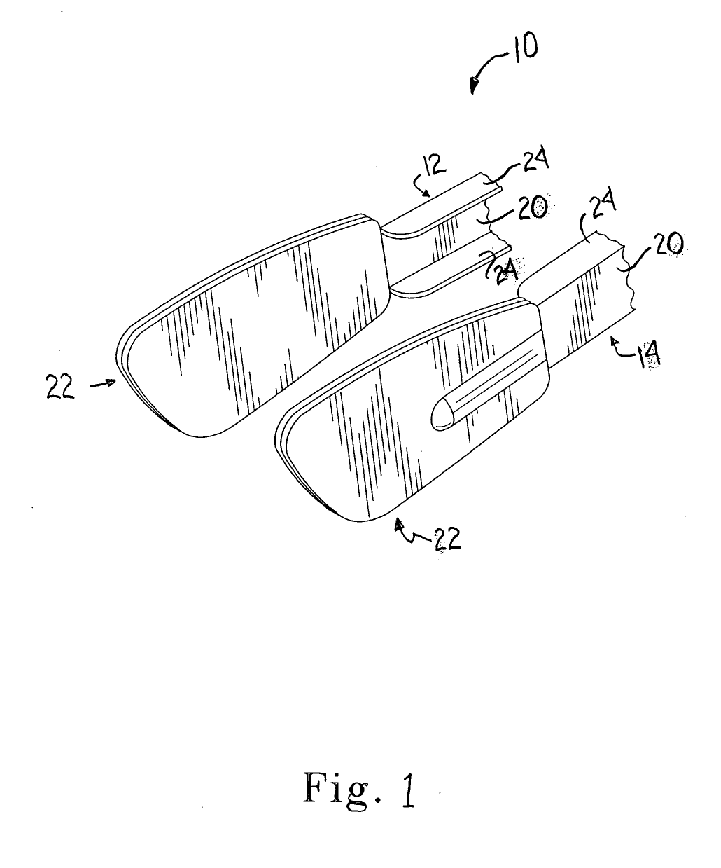

Referring to FIGS. 1-3, there is illustrated a kitchen utensil, namely kitchen tongs, generally designated by the numeral 10. The tongs 10 have a first arm 12 typically pivotally connected to a second arm 14 at a pivot point (not shown). Generally speaking, each arm 12, 14 of tongs 10 comprises a body portion 20 and a workpiece engaging end referred to as the grasping end or head 22. The pivot end of the tong may be comprised of any known mechanism used by those skilled in the art, including the locking design shown and described in co-pending U.S. patent application Ser. No. 11/283,101, filed Nov. 18, 2005 and entitled “Tongs with Encapsulated Locking Mechanism.” The disclosure of the '101 application is hereby incorporated by reference.

Each arm 12, 14 preferably has a substantially U-shaped cross-section with a small lobe 24 on each side of body 20 to form a channel and provide rigidity. The width of the two formed channels of the body 20 are such that one fits into the span of the other as the lobes 24 overlap to some extent when the arms 12, 14 are brought together in a closed position. The body 20 of each arm 12, 14 has a rigid channeled cross-section connecting the pivot end to the workpiece-engaging, grasping end or head 22. The length of the body 20 is a function of design choice and the intended use of the tongs 10. Finally, the grasping end or head 22 of each arm 12, 14 culminates in a somewhat flattened, broad food-engaging member having first and second edges 30, 32, respectively.

Referring to FIGS. 1-3, the grasping end or head 22 of each arm 12, 14 is comprised of a mounting flange 16 integral to and extending from the tong body 20. The rigid channeled body 20 flattens about the periphery to form a substantially planar and somewhat rectangular body having a central, structural, reinforcing brace 17, also integral to the body of the flange 16. The brace 17 is preferably provided in the form of a deepening furrow running in alignment with the tong body 20. The exterior of the brace 17 is preferably rounded to avoid the occurrence of sharp edges. However, other configurations for a brace known to those skilled in the art could certainly be used to provide the necessary structural support to the otherwise flexible tong head 22.

The flange 16 is also comprised of a plurality of connection points 33a for affixing the core 18 of the tong head 22. The four connection points 33a shown are spaced about the flange periphery to provide a suitable even connection between the components. In the present embodiment, the core 18 has a significantly larger surface area than the flange 16. This allows the core 18 to be bendable as it is preferably made of a flexible material, such as spring steel, but may also be made from a thin sheet of material, such as stainless steel, which provides flexibility at relatively small thicknesses. The core 18 is also provided with a plurality of corresponding connection points 33b to align with the connection points 33a of the flange 16.

The connection between the two components may be made by any known method, including the use of rivets, spot welding, epoxy or similar chemical bonding compositions, and other effective means. Alternatively, it is possible that the core 18 could be made integral to the flange 16, negating the need for providing additional connection between the components. When connected, the core 18 and flange 16 form a substantially flat tong head 22.

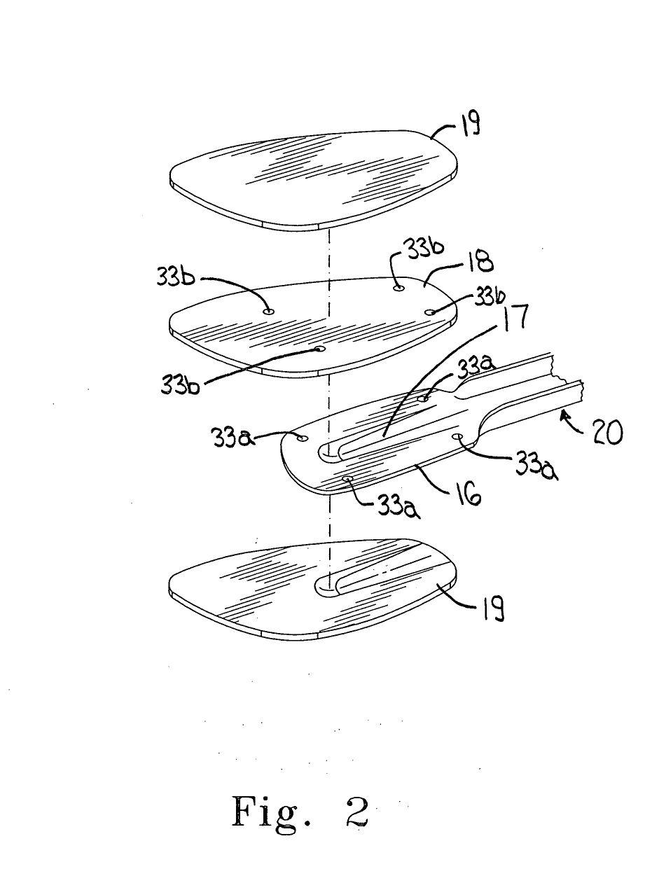

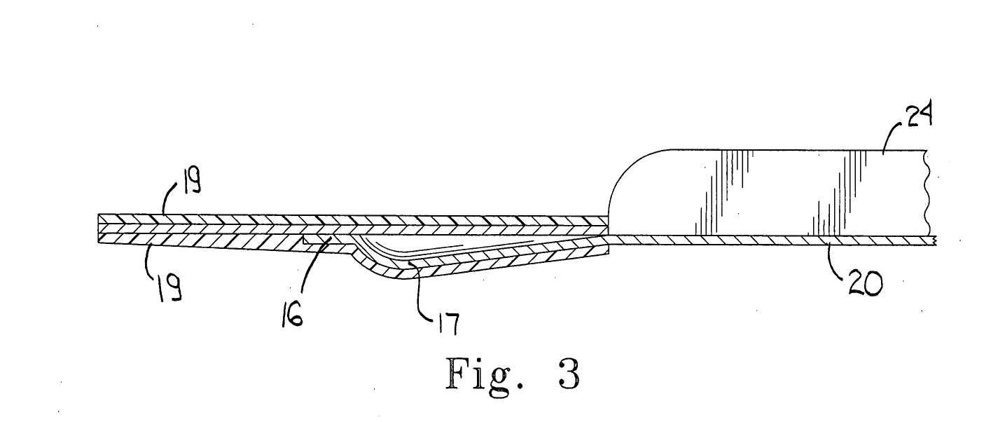

To the outside of the core 18 is affixed an outer layer 19, as illustrated in FIGS. 2 and 3, comprised of a second flexible material, preferably silicone. The second flexible material may be applied to the core 18 by any method known to those skilled in the art. The preferred method for applying the flexible material to the core 18 is compression molding. As shown in FIG. 2, the outer layer 19 is comprised of two layers adhered to all surface of the core 18, including top and bottom surfaces and edges. However, such flexible material may be applied to only a portion of the flexible core 18. For example, silicone may be applied to only one surface or only to the periphery and edges of the core without covering the connection and brace area. Other variations are possible and considered to fall within the scope of the present claims.

Additionally, other configurations of the core 18 are certainly possible which achieve the need to provide a tong head 22 which is both sufficiently rigid and sufficiently flexible to handle various food items without damaging the surface of kitchen containers, such as pots, pans, bowls or the like.

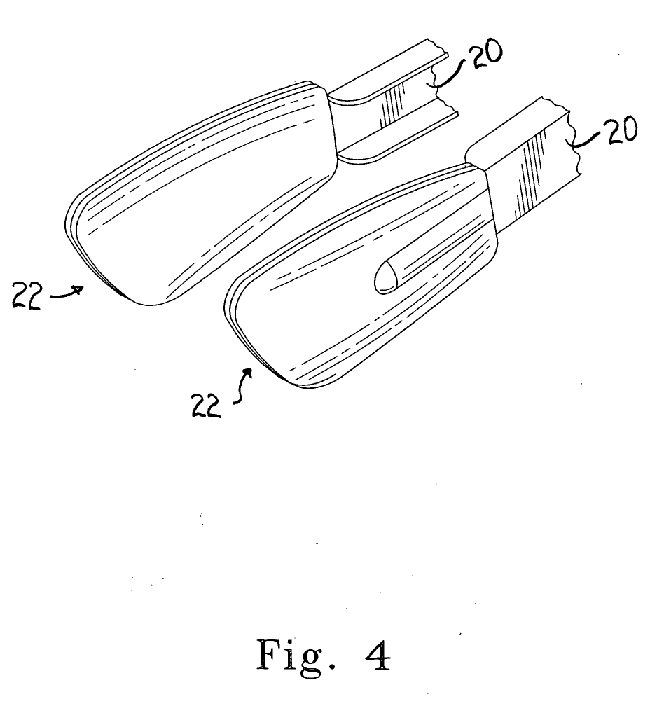

As an alternative to the flat tong head of FIG. 1, FIG. 4 illustrates tong heads 22 having a slight bow imparted. The bow may be either transverse to the tong arm 12, 14, axial to the tong arm, or both, giving it a cupped form. In order to impart the bow, the flange 16 is preferably bowed sufficiently such that connection of the core 18 results in the desired bow. The bow, of course, provides resistance in the core layer to flexing outward against the bow while still maintaining a sufficient inward flexibility. Traditionally, tong heads have a cupped-shape to better grasp food items.

Additionally, though not specifically illustrated in the appended drawing figures, the tong heads 22 may be different from one another. That is, one head may be configured to be flat, as illustrated in FIG. 1, while the second head may be cupped, as shown in FIG. 4. The two heads may be cupped or bowed to different degrees as well. Those skilled in the art would understand that such common heads, mixed and matched, would be within the scope of the pending claims, and would merely be a matter of design choice based on the primary intended function of the tongs 10.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A kitchen utensil comprising a first arm and a second arm, each arm comprising a grasping end, a body, and a pivot end, wherein the first and second arms are pivotally connected to one another at their respective pivot ends, the grasping end of each arm comprising a head made of a flexible core material and at least a substantial portion of the head being covered by a flexible outer material.

2. The kitchen utensil of claim 1, wherein the kitchen utensil is a pair of food tongs.

3. The kitchen utensil of claim 1, wherein the flexible core material comprises flex steel.

4. The kitchen utensil of claim 1, wherein the flexible outer material comprises silicone.

5. The kitchen utensil of claim 1, wherein the head comprises a bow for improved structural integrity.

6. The kitchen utensil of claim 1, wherein the body of the first and second arms comprises a mounting flange for securing the head of the grasping end.

7. The kitchen utensil of claim 6, wherein the mounting flange is configured to impart a bow to the head.

8. The kitchen utensil of claim 1, wherein the entire head is covered by a flexible outer material.

9. The kitchen utensil of claim 8, wherein the flexible outer material comprises silicone.

10. The kitchen utensil of claim 9, wherein the silicone is compression molded to the head.

11. The kitchen utensil of claim 4, wherein the silicone is compression molded to the head.

12. A pair of food tongs comprising:
a first rigid arm structure having first and second opposed ends;
a second rigid arm structure having first and second opposed ends, the first end of the second rigid arm structure being pivotally connected to the first end of the first rigid arm structure;
a grasping head affixed to one of either the second end of the first rigid arm structure and the second end of the second rigid arm structure;
wherein the grasping head comprises a flexible core material, a substantial portion of which is covered by a flexible outer material.

13. The food tongs of claim 12, further comprising a grasping head affixed to the other of either the second end of the first rigid arm structure and the second end of the second rigid arm structure.

14. The food tongs of claim 12, wherein the flexible core material comprises flex steel.

15. The food tongs of claim 12, wherein the flexible outer material comprises silicone.

16. The food tongs of claim 12, wherein the head comprises a bow for improved structural integrity.

17. The food tongs of claim 12, wherein the second end of one of either the first rigid arm structure and the second rigid arm structure comprises a mounting flange for securing the grasping head.

18. The food tongs of claim 17, wherein the mounting flange is configured to impart a bow to the head.

19. The food tongs of claim 15, wherein the silicone is compression molded to the head.
